(19) United States
(12) Patent Application Publication
(10) Pub. No.: US 2005/0008752 A1
(43) Pub. Date: Jan. 13, 2005

(54) Beverage whitener formulation

(76) Inventor: Elizabeth Clare Charman, Totton (GB)

Correspondence Address: FULBRIGHT & JAWORSKI, LLP, 1301 MCKINNEY, SUITE 5100, HOUSTON, TX, 77010-3095, US

(21) Appl. No.: 10/494,106

(22) PCT Filed: Nov. 11, 2002
(86) PCT No.: PCT/GB02/05070

(30) Foreign Application Priority Data
Nov. 12, 2001 (GB) 0127138.6

(51) Int. Cl. C12C 1/00

(52) U.S. Cl. 426/590

(57) ABSTRACT

A powdered beverage whitener composition comprising, by weight based on the dry weight of the composition: from about 50% to about 80% of a milk powder; from about 5% to about 30% of whey solids, and from about 10% to about 30% of one or more added sugars. The invention therefore further provides a beverage whitener composition comprising, based on the dry weight of the whitener, from about 10% to about 60% of milk proteins and from about 25% to about 85% of sugars, wherein the milk proteins include added whey proteins. Preferably the whitener comprises less than about 2% by weight of fats. Also provided are beverage brewing capsules containing the whitener, and a method of brewing foamy beverages by dispersing the whitener in water and mixing the dispersion with high shear. The whitener compositions are especially suitable for preparing foamy beverages, such as cappuccino coffee.

### CROSS-REFERENCE TO RELATED APPLICATIONS

This Application is a national stage filing of PCT/GB02/05070 filed Nov. 11, 2002 claiming priority to GB 0127138.6 filed Nov. 12, 2001.

### TECHNICAL FIELD

The present invention relates to powdered beverage whitener formulations, and in particular to powdered beverage whitener formulations for use in the production of foamed beverages.

### BACKGROUND OF THE INVENTION

Powdered skim milk is not currently preferred as a whitener for beverages such as coffee or tea, because of unsatisfactory color, taste, cost and dispersibility. A further problem is that, because of its natural origin, the taste of skim milk can vary with the season. Instead of skim milk, it is preferred to use one of the many non-dairy beverage whitener formulations. These typically comprise various ingredients such as carbohydrate, fat, protein, emulsifier, and salts dissolved and/or dispersed in water and homogenized to provide a liquid emulsion concentrate having a solids content of typically about 45-70%. The liquid emulsion concentrate thus formed, is spray dried to a moisture content of no more than 5%. The dried product when added to an aqueous medium such as coffee or tea forms a reconstituted oil-in-water emulsion which whitens and flavors the beverage. A typical formulation, on a dry weight basis, for a spray-dried coffee whitener is as follows:
Vegetable fat (e.g. coconut oil) 20-40%
Carbohydrate (e.g. glucose, corn syrup solids, sucrose) 50-75%
Protein (e.g. sodium caseinate) 2-6%
Stabilizing salt (e.g. dipotassium phosphate)1-3%
Emulsifier (e.g. mono- and diglycerides) 0.5-2.0%,
Color, Flavoring agents and anti-caking agents as appropriate.

In such dry coffee whitener formulations, the vegetable fat or oil provides whitening effect, body and viscosity. The carbohydrate acts as a carrier for the fat to retard coalescence of the fat and provides some sweetness effect. Emulsifiers are incorporated in the formulation to maintain the fat globules in dispersion when the emulsion concentrate is prepared. The protein, usually sodium caseinate, has been found to be necessary to stabilize the emulsion through the drying step so that when the dried product is reconstituted in coffee, a stable emulsion is provided.

It is known that dried coffee whiteners containing sodium caseinate exhibit feathering in coffee under certain conditions, such as when the water used in making the coffee has a high calcium or magnesium ion content, or when the coffee is very acidic. As a result, most researchers in the field of non-dairy beverage whiteners have sought to minimize the amount of protein in the formulation. See, for example, U.S. Pat. No. 4,857,341.

An exception to the above trend of research is U.S. Pat. No. 4,689,245, which describes a low-fat dairy coffee whitener made by spray drying a skim milk that has been treated by ultrafiltration to remove a substantial part of the lactose and dissolved salts naturally present in skim milk. The resulting powdered whitener comprises about 49-65% of protein, about 23-38% of lactose, about 7.6-7.8% of ash, about 3.9-4.6% of moisture, about 0.50-0.53% of fat, about 1.70-2.08% of calcium, and about 22-35 milligrams of sodium in 100 grams of the powder. This whitener composition is relatively expensive on account of the high milk solids content and the additional ultrafiltration step.

GB-A-2154422 describes powdered beverage whitener formulations comprising from 0.2 to 28% of fats, 5 to 16% of proteins, 16 to 62% of lactose and, optionally, up to 60% of other carbohydrates, wherein the ratio by weight of proteins to lactose is from 1:3.5 to 1:5. For comparison, the ratio of proteins to lactose in whole natural milk is about 1:1.4. The low protein to lactose ratio in the formulations of GB-A-2154422 is likely to result in unsatisfactory foam formation.

It is known to form edible foams from fresh milk, for example in milk shakes. It is also known to serve coffee and other hot beverages with a layer of hot milk foam over the liquid beverage. The hot milk foam is traditionally made by injecting steam under pressure through a hollow steam wand into cold fresh milk (whole, skimmed or semi-skimmed) to heat and foam the milk. The milk foam is then poured or spooned onto liquid coffee to form the beverage, for example cappuccino or latte.

The milk foaming is normally carried out separately from the coffee brewing, because the essential oils present in coffee have a deleterious effect on foaming.

The traditional method of forming hot milk foam for cappuccino or latte does not lend itself to use in beverage vending installations. This is in part because fresh or liquid milk is difficult to handle in such installations. Furthermore, most vending installations are not equipped to supply steam under pressure. In addition, the use of a steam wand immersed in the liquid milk could present cross-contamination problems.

It is known, for example from EP-A-0458310, to provide a powdered beverage whitener containing encapsulated nitrogen or carbon dioxide gas that produces a foam when it is dispersed in coffee. However, the foam does not have the same bulk and stiffness (spoonability) as a conventional cappuccino foam. A foam height of at least about 3 mm is desired. Furthermore, the stability of these foams is not as high as for the foams made by steam injection.

It is also known to produce a foam in a vending machine by depositing a powdered milk into a cup, followed by jetting hot water into the cup to dissolve the powdered milk and foam the milk by the action of high shear between the water jet and the milk. This suffers from the reduced consumer acceptability and mess associated with depositing a powdered milk into the cup. Furthermore, existing milk powder formulations do not dissolve completely and do not provide optimum foaming. In order to achieve more complete dissolution and foaming of the powder it is necessary to move the jet relative to the cup by means of an X-Y table or similar equipment, thereby increasing the cost of the apparatus.

In copending patent application PCT/GB02/01945 there is described a method for the preparation of a foamed drink comprising the steps of: providing a capsule containing a whitener and having an outlet for allowing fluid to escape from the capsule; providing a receptacle positioned to collect fluid escaping from the capsule through the outlet; injecting aqueous liquid into the capsule to mix with the whitener; allowing the whitener mixed with the aqueous liquid to escape through the outlet into the receptacle; followed by injecting further aqueous liquid into the receptacle through a jet having a jet diameter of from about 0.5 to about 2 mm to produce a foamed liquid in the receptacle by high-shear mixing. The whitener is normally a foamable powdered beverage whitener.

The present invention relates to improved powdered beverage whiteners that give high volumes of stable foam when mixed with water at high shear, have good dispersibility in water, and provide good organoleptic properties and appearance when added to beverages such as tea and coffee. Achieving a balance of these properties is difficult, and has been achieved by the specific whiteners according to the invention.

### BRIEF SUMMARY OF THE INVENTION

The present invention relates to powdered beverage whitener formulations, and in particular to powdered beverage whitener formulations for use in the production of foamed beverages.

In a first aspect, the present invention provides a powdered beverage whitener composition comprising, by weight based on the dry weight of the composition: from about 50% to about 80% of a milk powder; from about 5% to about 30% of whey solids, and from about 10% to about 30% of one or more added sugars.

In a second aspect, the present invention provides a method of making a powdered beverage whitener composition comprising the step of mixing, by weight based on the dry weight of the composition: from about 50% to about 80% of a milk powder; from about 5% to about 30% of whey solids, and from about 10% to about 30% of one or more added sugars.

It has been found that the beverage whiteners formulated in this way are relatively easy to disperse in water, and produce high and stable volumes of foam following high-shear mixing with hot water. The organoleptic properties of the foams and resulting beverages are at least as good as, and in many cases better than, the best skim milk powder alone.

The milk powder is preferably a skim milk powder, since the foams produced from skim milk powder are more stable than those obtained with higher fat milk powders. Typically, the skim milk powder comprises, by weight based on the dry weight of the skim milk powder, from about 30 to about 40% by weight of proteins (of which κ-casein, β-casein and αₛ₁-casein are the most important), from about 50 to about 60% by weight of lactose, less than about 2% by weight of fat, and up to about 15% of minerals (such as salts and vitamins) and trace components.

The whey solids may be derived from sweet whey, de-mineralised whey, whey isolate, whey permeate or whey concentrate. Sweet whey solids comprise, by weight based on the dry weight of the solids, from 5 to 20% by weight of whey proteins (of which beta lactoglobulin is the most important), from about 60 to about 80% by weight of lactose, less than about 2% of fats, and the balance minerals and trace components. Whey isolate contains a higher fraction of the whey proteins, and whey permeate contains a lower fraction of these proteins. The whey proteins are more heat stable than the casein proteins present in the milk powder. The whey solids are, of course, present as an added component over and above any whey components inherently present in the milk powder.

The added sugars (i.e. sugars added over and above those present in the milk powder or skim milk and the whey solids) may for example comprise lactose, glucose, maltose, sucrose, corn syrup solids, or mixtures thereof. Lactose and glucose are preferred, and mixtures thereof are especially preferred.

Overall, the whitener made according to the first or second aspects of the present invention preferably comprises, based on the dry weight of the whitener, from about 10% to about 60% of proteins, and more preferably from about 20% to about 60% of proteins, since a higher protein content promotes foam formation. Preferably, the same whitener comprises from about 25% to about 85% of sugars, and more preferably from about 40% to about 75% of sugars. Preferably the same whitener comprises less than about 10% by weight of fats more preferably less that about 5% of fats, most preferably less than about 2% of fats. The balance of the composition is normally substantially made up of minerals (especially salts and vitamins). Preferably, the same whitener comprises less than 10 wt. % of water, preferably less than 5 wt % of water.

In a third aspect the present invention therefore provides a beverage whitener composition comprising, based on the dry weight of the whitener, from about 10% to about 60% of milk proteins and from about 25% to about 85% of sugars, wherein the milk proteins include added whey proteins. Preferably the whitener comprises less than about 2% by weight of fats. The balance of the composition is normally substantially made up of minerals (salts and vitamins). Preferred ranges and moisture contents are as specified above in relation to the first and second aspects of the invention.

The whitener compositions according to any aspect of the invention normally have a ratio by weight of proteins of proteins to lactose of less than −3.5, preferably less than about 3, more preferably from about 2 to about 3.

The particle size distribution of the whitener is also important for optimising dispersibility in hot water. Preferably, at least about 70% by weight of the particles, more preferably at least about 80% by weight of the particles, have a size in the range 180 to 850 micrometers, as determined by sieve separation. Preferably, less than 10% by weight of the particles pass a 180 micrometer sieve, as it has been found that such fine particles tend to result in lumps of the whitener in use. Particles larger than 850 micrometers-may not completely dissolve in the beverage preparation process.

The starting materials for making the whiteners according to the present invention may be substantially dry and free-flowing powders. In the alternative, hydrous starting materials can be used, such as skim milk concentrate, whey concentrate, or glucose syrup.

In certain embodiments the compositions according to the present invention may be formulated by dry mixing the constituent materials in powdered form. The mixture may then for example be subjected to rewet agglomeration by passing the powder through a fine water spray and/or steam to cause the particles to agglomerate, followed by drying.

In other embodiments, the compositions are prepared by spray drying a liquid dispersion of all three components, the dispersion typically having a solids content of 45-55%. Such spray drying can be difficult, and is preferably carried out by so-called filter mat spray drying, or in a tall form dryer.

In either process, the particles may be comminuted and/or size separated to achieve the desired particle size range.

In a further aspect the present invention provides a capsule containing a beverage whitener made according to any of the above aspects of the present invention.

The term “capsule” refers to any non-resealable portion pack containing a predetermined amount of the whitener. The capsule is normally disposable after one use. In certain embodiments the capsule is a beverage brewing capsule adapted to be received in a beverage brewing apparatus for the preparation of a portion of beverage. The capsule may comprise at least one side formed from a substantially rigid sheet material. For example, capsules having substantially cylindrical or truncated conical shapes are envisaged. More typically the capsule comprises a body formed at least in part from flexible film material, for example a tubular sachet formed on a form-fill-seal machine, or a sachet formed by bonding together front and back sheets of film material around the edges thereof to define a sachet. The capsule will normally be substantially air and moisture impermeable before use in order to preserve the whitener in a shelf stable condition. Preferably, the capsule is substantially shelf stable. That is to say, it may be stored at ambient temperature and atmospheric conditions for a period of at least 3 months, preferably at least one year, without significant deterioration of the contents.

In certain embodiments the internal volume of the capsule is from about 25 to about 100 cm³. The internal volume refers to the maximum volume of the capsule when any flexible parts are fully distended. This internal volume is typically at least twice the volume of the whitener ingredient, in order to allow space for turbulent flow and mixing of the aqueous liquid with the ingredient in the capsule.

The capsule may be provided with an inlet nozzle, for example as described in EP-A-0179641 or WO-A-9905036. In certain embodiments the method may comprise injecting liquid into two or more inlets in the capsule in order to improve mixing with the whitener. The two or more inlets may be connected through a manifold to a single liquid inlet duct. At least one of the inlets may be angled to assist turbulent mixing and washing out of the capsule.

In certain embodiments the outlet of the capsule is sealed by freshness barrier. The term “freshness barrier” refers to a barrier that is substantially impermeable to air or moisture so as to preserve the freshness of the whitener by preventing ingress of air or moisture through the liquid guide before brewing commences. The freshness barrier may be released by an external mechanical force or thermal field applied during brewing. The freshness barrier is preferably releasable by the action of pressure and/or hot water from inside the capsule during brewing. For example, the freshness barrier may comprise a layer of a sealant that is released by the action of heat and/or moisture, such as an adhesive as described in EP-A-0179641 or WO99/05036.

For example, in certain embodiments the capsule comprises two flexible sheets bonded together along a seam situated opposite the inlet, said bonding being releasable by the action of heat or pressure inside the capsule, whereby the two sheets peel apart under said action to provide said opening.

Preferably, where the outlet is sealed by a freshness barrier as hereinbefore described, the injection of liquid into the capsule initially causes mixing with the whitener. The freshness barrier is then released to form said opening, thereby releasing the whitener into the receptacle.

In certain embodiments, the capsule according to the present invention comprises an inlet for injecting a liquid into the capsule; and an outlet for allowing liquid to escape from the capsule, wherein at least one of the inlet and outlet comprises a constriction for providing a liquid jet having a diameter of from about 0.5 to about 2 mm.

The inlet or outlet is adapted to provide a narrow diameter liquid jet into the interior of the capsule, and/or out of the interior of the capsule in use. The resulting high shear mixing when the jet hits a liquid surface containing the foamable ingredient results in foam formation.

Preferably, the constriction provides a jet having a diameter of from about 0.7 to about 1.5 mm, more preferably about 1 mm.

In certain embodiments the capsule may comprise two or more jet-forming inlets or outlets in order to combine high shear with an increased liquid flow rate. The two or more inlets may be connected through a manifold to a single liquid inlet duct. At least one of the inlets may be angled to assist swirling and washing out of the capsule.

The internal cross-section of the jet-forming inlet or outlet is normally a regular shape, and preferably it is substantially circular. Since aqueous liquids are substantially incompressible and not significantly viscoelastic, it follows that the internal cross sectional area of the jet-forming region of the inlet and/or the outlet is generally from about 0.2 to about 3 mm², preferably from about 0.4 to about 2 mm², for example about 1 mm₂.

If the constriction (narrow bore, jet forming region) of the inlet or outlet is too short, then the inlet or outlet tends to form a spray rather than a jet. If the constriction is too long, then the pressure drop across the constriction may be too high. Accordingly, the constriction preferably extends for a distance of from about 1 to about 5 mm, preferably about 2 to about 4 mm along the direction of liquid flow.

In certain embodiments the jet forming region of the inlet or outlet may comprise a disposable nozzle. The nozzle may be formed by injection moulding of plastic material and may be inserted in liquid-tight fashion into a seal between front and back sheets of film material making up the capsule, substantially as described in EP-A-0179641 or WO-A-9905036. In these earlier documents the bore area of the nozzle was substantially greater than 3 mm² in order to provide rapid flow of liquid into the sachets. The nozzle in the capsules according to the present invention may comprise an inlet duct of diameter about 3 mm or more for compatibility with existing beverage brewing machines, but the exit from the nozzle may have a constricted cross-section to form a jet as hereinbefore described. The disposable inlet or outlet nozzle provides the advantage that it does not get blocked by scale or contaminated by prolonged use.

The dry weight of the whitener in the capsule may preferably be from about 1 to about 50 g, preferably from about 5 to about 0.15 g. In other words, the amount of the composition is preferably sufficient for one portion of a foamed product, e.g. one cup of a foamy beverage. It has been found that increasing the amount of whitener does not proportionately increase the amount of foam produced by the high shear mixing with a given amount of hot water.

The present invention further provides a method of making a foamed beverage comprising the steps of: providing a whitener composition according to the present invention, and dispersing the composition in water with high shear mixing to form a foamed liquid dispersion.

The dry weight of the foamable composition used in the method may typically be from about 1 to about 50 g, preferably from about 5 to about 15 g. In other words, the amount of the composition is preferably sufficient for one portion of a foamed product, e.g. one cup of a foamy beverage.

Preferably, the step of dispersing comprises low shear mixing to disperse the composition in water followed by the high shear mixing to foam the dispersion. Preferably, the high shear mixing is provided by injecting a high velocityjet of water into the dispersion.

Preferably, the method according to the invention comprises the steps of: providing a capsule according to the present invention containing the foamable whitener and having an outlet for allowing fluid or powder to escape from the capsule; providing a receptacle positioned to collect fluid or powder escaping from the capsule through the outlet; injecting aqueous liquid into the capsule to mix with the foamable whitener; allowing the foamable whitener mixed with the aqueous liquid to escape through the outlet into the receptacle; followed by injecting further aqueous liquid into the receptacle through a jet having a jet diameter of from about 0.5 to about 2 mm to produce a foamed liquid in the receptacle.

The method according to the invention initially operates by enabling, first, turbulent mixing of the liquid and the foamable whitener in the capsule, followed by deposition of the resulting mixture into the receptacle and jetting liquid into the mixture in the receptacle to provide foaming. The use of a capsule removes earlier problems with direct deposition of milk solids into a receptacle and provides a better quality foam in larger quantities.

Preferably, the aqueous liquid consists essentially of water, optionally mixed with steam. In certain embodiments the liquid is injected into the capsule at a pressure of from about 30 kPa (0.3 bar) to about 200 kPa (2 bar). These pressures are suitable for use in vending equipment without special measures.

In certain embodiments the liquid is injected in a two stages: a first, relatively low pressure stage to achieve mixing with the foamable whitener without bursting the capsule, followed by a second, high pressure stage to open the outlet and release the contents into the receptacle

Preferably, the liquid is injected into the capsule containing the foamable whitener by a peristaltic or piston pump, preferably at an average rate of from about 250 to about 2000 ml/min and more preferably from about 500 to 1500 ml/min. The liquid may be injected in intermittent or pulsed fashion to optimise the amount of foam or the organoleptic properties of the product. Preferably, the method further comprises the step of injecting air into the capsule after injecting the liquid to expel residual liquid from the capsule.

In certain embodiments the total amount of liquid injected into the capsule containing the foamable whitener is from about 25 ml to about 100 ml. For a hot foamed beverage the temperature of the liquid is typically from about 75 to about 100 degrees C.

The step of injecting liquid into the capsule containing the foamable whitener is followed by the step of injecting a jet of liquid into the receptacle containing the liquid/foamable whitener mixture. The high velocity and narrow-diameter of the liquid jet provide strong shear forces that give rise to the formation of a thick foam.

The jet is normally formed by pumping liquid into a narrow-bore jet-forming inlet. The inlet may be situated adjacent to the capsule containing the whitener. Alternatively, the inlet may be moved into the place of the capsule following ejection of the capsule from the beverage brewer. The internal cross-section of the jet-forming inlet is normally a regular shape, and preferably it is substantially cylindrical. Preferably, a circular water jet is produced having a diameter of from about 0.5 to about 2 mm, preferably from about 0.7 to about 1.5 mm. Since water is substantially incompressible and not significantly viscoelastic, it follows that the internal cross sectional area of the jet-forming region of the inlet and/or the outlet is generally from about 0.2 to about 3 mm², preferably from about 0.4 to about 2 mm², for example about 1 mm².

If the narrow bore, jet forming region of the inlet is too short, then the inlet tends to form a spray rather than a jet. If the narrow bore is too long, then the pressure drop across the inlet may be too high. Accordingly, the narrow bore region preferably extends for a distance of from about 1 to about 5 mm, preferably about 2 to about 4 mm along the direction of liquid flow.

Typically, the jet velocity of the liquid jet is from about 3 to about 50 m/s, preferably from about 5 to about 15 m/s. This gives sufficient shear on impact with a liquid body in the receptacle to provide effective foaming. The temperature of the liquid is preferably from about 80 to about 100° C. The liquid is preferably supplied to the inlet at a pressure of from about 0.4 to about 2 bar (40 to 200 kPa), preferably about 0.8 to about 1.2 bar (80 to 120 kPa) which is achievable with conventional vending equipment. The flow rate per jet is preferably from about 4 to about 40 ml/sec, preferably from about 6 to about 18 ml/sec. A plurality of jets may be provided to speed up the rate of liquid addition and foam formation. Preferably, at least one liquid jet is inclined at an angle to the vertical in order to achieve swirling of the liquid in the receptacle. Preferably, the total amount of liquid jetted into the receptacle is from about 30 to about 150 ml, more preferably from about 50 to about 100 ml.

The receptacle is typically a cup, for example a polystyrene cup. Typically, the bottom of the receptacle is located from 5 to 25 cm below the outlet of the capsule.

It is occasionally found that the method described above produces a foam having undesirable large bubbles near the top. In such cases the method preferably further comprises the step of applying a water spray to the top of the foam in the receptacle after the step of water injection. The water spray disperses the larger bubbles. Typically the water spray is applied for 1 to 5 seconds and has a small droplet size.

The method of the invention normally comprises the step of holding the capsule in a beverage brewer before the step of injecting liquid into the capsule. Preferably, the method further comprises the step of mechanical ejection of the capsule from the holder after the step of injecting liquid into the capsule. For example, the beverage brewer may comprise a waste bin into which the capsule is automatically and mechanically discarded. Preferably this takes place before or during the step of injecting further liquid.

Preferably, the methods according to the present invention further comprise adding a liquid beverage to the foamed liquid dispersion. For example, the liquid beverage may be coffee, tea or chocolate. Where coffee is added, the resulting beverage is a cappuccino-style coffee.

Sensory evaluation tests carried out on foamed beverage whiteners according to the present invention have shown that they exhibit excellent organoleptic properties comparable to skim milk alone. Furthermore, the compositions of the invention provide higher perceived “creaminess” of the foamed beverages relative to skim milk alone.

### BRIEF DESCRIPTION OF THE DRAWINGS

The present invention will now be described further, by way of example, with reference to the following drawings, in which:

FIG. 1 shows a plan view of a capsule containing a foamable whitener according to the present invention;

FIG. 2 shows a longitudinal sectional view through the capsule of FIG. 1; and

FIG. 3 shows the capsule of FIGS. 1 and 2 after injection of liquid into the capsule has-been completed, and while further injection of a jet of liquid into a receptacle is taking place.

### DETAILED DESCRIPTION OF THE INVENTION

### EXAMPLE 1

A whitener composition according to the invention was prepared from the following ingredients supplied by Domo, of 8000 AK Zwolle, The Netherlands:
Skimmed milk powder (Dutch milk pool, medium heat treatment) having the composition: protein 36%, lactose 51%, minerals 8%, fat 1%, moisture 4%. Sweet Whey powder (DV 100) having the composition: protein 12%, lactose 74%, minerals 8%, milk salts 3%, fat 1%, moisture 3%.
Lactose (alpha, crystalline powder).

The ingredients were mixed in the proportions, by weight, of 59.7% skimmed milk, 24.9% whey powder, 14.9% lactose powder and optionally 0.5% flowing agent. The resulting whitener therefore had overall composition about 25% proteins, about 64% lactose, about 7% minerals and about 1% fats.

The dry mixture was subjected to rewet agglomeration with steam at 0.08 bar (no water). The product was sieved to achieve less than 10% by weight fines below 120 micrometers, and the fines were reworked through the process or the agglomerator was controlled to reduce the fines level below 10%. Any oversize was milled during manufacture and reworked into the process. Particles that were too hard to mill were rejected as waste. In this way particle size above 850 micrometers was reduced to less than 5% by weight.

### EXAMPLES 2-5

The procedure of Example 1 was repeated with the following formulations:

| | Skimmed | | | |
|---|---|---|---|---|
| Example | Milk | Whey | Lactose | Glucose* |
| 2 | 67 | 11 | 4 | 18 |
| 3 | 58 | 23 | 4 | 15 |
| 4 | 80 | 5 | 15 | 0 |
| 5 | 70 | 14 | 5 | 11 |

*as 21 or 28 glucose syrup

### EXAMPLES 6-7

The following mixtures were made up for spray drying:

| | Example 6 | Example 7 |
|---|---|---|
| Liquid Skimmed Milk | 67% | 67% |
| Whey Powder | 11% | — |
| Glucose Syrup DE28 | 18% | 22% |
| Lactose | 4% | — |
| Whey Permeate | — | 11% |

The mixtures were concentrated and spray dried to provide compositions according to the present invention.

### EXAMPLE 8

A capsule according to the present invention was prepared as follows.

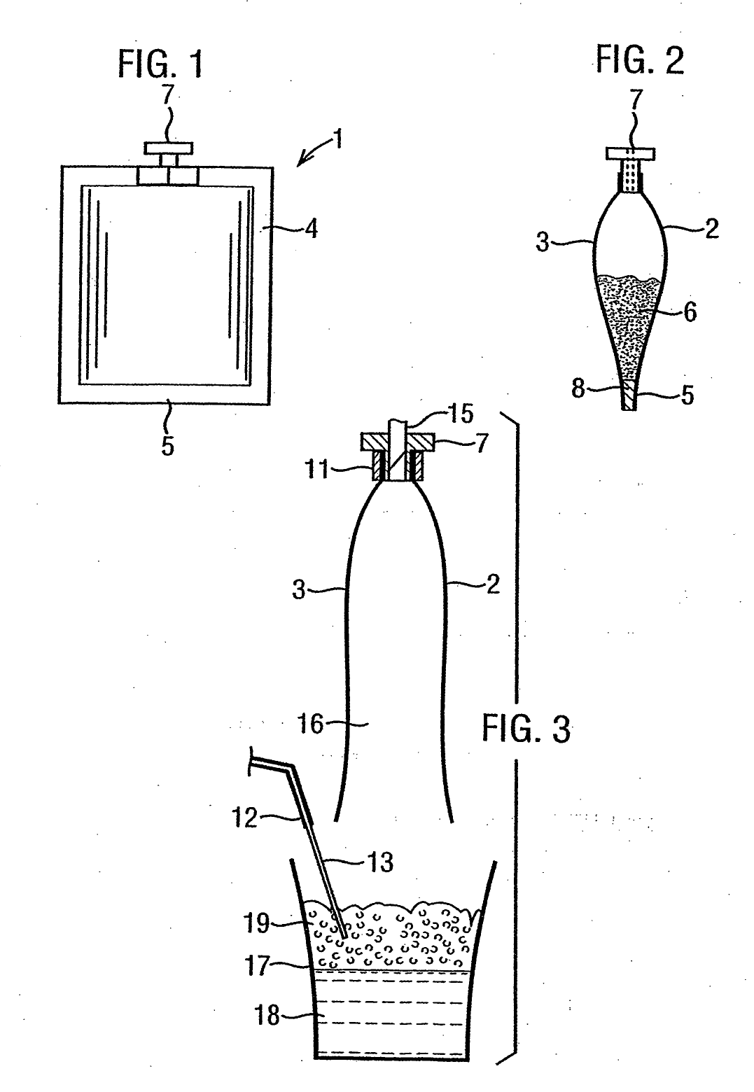

Referring to FIGS. 1 and 2, the capsule 1 was in the form of a sachet formed from two sheets of laminated, metallised flexible plastic film 2,3 bonded together around a margin 4. A lower margin 5 of the sachet was bonded by means of a layer of adhesive 8 that can be released by the action of hot water inside the sachet. In a top margin of the sachet a nozzle 7 was inserted between the sheets 2,3 and bonded thereto in air tight fashion. The capsule had an internal volume of approximately 50 cm³ when fully distended. Thus far the construction of the package 1 was similar to the beverage brewing sachets described in EP-A-0179641 or WO99/05036. The capsule was approximately half filled with approximately 5-10 g of a whitener according to one of Examples 1-5.

The nozzle 7 was formed by injection moulding of a thermoplastic material such as polypropylene. It was bonded by adhesive or melt bonding in air tight fashion to the front and back sheets 2, 3 of the sachet. The nozzle 7 comprised a bore region having an internal diameter of approximately 3 mm, into which a water injection tube 15 was inserted in use. A flange was provided at the top of the nozzle to assist mechanical gripping and manipulation of the sachet in the brewing apparatus. Finally, a plastics laminated foil freshness barrier (not shown) was sealed over the top of the nozzle. This resulted in a fully air tight and moisture-tight package that was shelf stable.

### EXAMPLE 9

The capsule of Example 8 was used to prepare a foamed beverage by a method according to the present invention, as follows.

With reference to FIG. 3, in use the capsule 1 was inserted into a FLAVIA 350 beverage brewer by capsule holder 11 which grips the capsule below the nozzle flange. A water inlet tube 15 was advanced to pierce the freshness barrier in the nozzle 7, and hot water at about 90° C. was then injected through the tube 15 into the capsule 1. The hot water underwent turbulent mixing with the whitener 6 in the capsule 1 to produce an aqueous dispersion of the whitener. The hot water also released the seal 8 at the bottom of the capsule, thereby allowing the aqueous whitener dispersion to drop into the receptacle 17. The total amount of water injected in this stage was about 50 ml.

Once water injection into the capsule 1 was complete, the beverage brewer automatically jettisoned the used capsule into a waste receptacle. A jet of water 13 was then pumped into the liquid mixture in the receptacle 17 through jet inlet 12. The jet diameter was about 1 mm, the jet velocity was about 5 m/s and the amount of water injected through the jet was about 60 ml. The jet of water caused foaming of the mixture in the receptacle 17 to produce a foamed liquid comprising a liquid layer 18 and a foam layer 19.

The resulting foamed milky liquid normally required the addition of a beverage flavour to render it more palatable. In this example a beverage brewing capsule was inserted into the same holder in the beverage brewer. The beverage brewing capsule was constructed in similar fashion to the capsule of FIG. 1, but was filled with ground coffee, tea or chocolate and where necessary incorporated a filter element. The beverage was brewed by injection of hot water into the nozzle of the capsule in similar fashion as for the whitener capsule. The brewed coffee escaped from the bottom of the capsule and dropped through the foam layer 19 into the liquid layer 18 in the receptacle 17. A final jet of water was briefly injected through nozzle 12 to swirl the contents of the receptacle 17 and thereby mix the brewed beverage with the milky liquid already in the receptacle. The spent beverage brewing sachet was then automatically discarded by the brewer.

The above examples have been described for the purpose of illustration only. Many other embodiments of the present invention falling within the scope of the accompanying claims will be apparent to the skilled reader.

1. A powdered beverage whitener composition comprising, by weight based on the dry weight of the composition: from about 50% to about 80% of a milk powder; from about 5% to about 30% of whey solids, and from about 10% to about 30% of one or more added sugars.

2. A powdered beverage whitener composition according to claim 1, wherein the milk powder is a skim milk powder.

3. A powdered beverage whitener composition according to claim 2, wherein the skim milk powder comprises, by weight based on the dry weight of the skim milk powder, from about 30 to about 40% by weight of proteins, from about 50 to about 60% by weight of lactose, less than about 2% by weight of fat, and up to about 15% of minerals and trace components.

4. A powdered beverage whitener composition according to claim 1, wherein the whey solids comprise, by weight based on the dry weight of the solids, from 5 to 20% by weight of whey proteins, from about 60 to about 80% by weight of lactose, less than about 2% of fats, and the balance minerals and trace components.

5. A powdered beverage whitener composition according to claim 1, wherein the added sugars comprise lactose, glucose, maltose, sucrose, corn syrup solids or mixtures thereof.

6. A powdered beverage whitener composition, wherein the whitener comprises, based on the dry weight of the whitener, from about 10% to about 60% of proteins and from about 25% to about 85% of sugars and less than about 2% by weight of fats, and wherein the proteins comprise added whey proteins.

7. A powdered beverage whitener composition according to claims 1 and 6, wherein at least about 70% by weight of the particles, preferably at least 80% by weight of the particles, have a size in the range 180 to 850 micrometers.

8. A powdered beverage whitener according to claim 6, wherein the ratio of proteins to lactose by weight is less than 1:3.5.

9. A method of making a powdered beverage whitener composition comprising the step of mixing, by weight based on the dry weight of the composition: from about 50% to about 80% of a milk powder; from about 5% to about 30% of whey solids, and from about 10% to about 30% of one or more added sugars.

10. A method of making a powdered beverage whitener composition comprising the step of mixing, by weight based on the dry weight of the composition: from about 10% to about 60% of proteins and from about 25% to about 85% of sugars and less than about 2% by weight of fats, and wherein the proteins comprise added whey proteins.

11. A method according to claim 9 and 10, wherein said step of mixing is a dry mixing step, and is followed by a step of rewet agglomeration.

12. A method according to claim 9 and 10, wherein said step of mixing is a wet mixing step, and is followed by a step of spray drying.

13. A capsule containing a beverage whitener comprising a powdered beverage whitener composition comprising, by weight based on the dry weight of the composition: from about 50% to about 80% of a milk powder; from about 5% to about 30% of whey solids, and from about 10% to about 30% of one or more added sugars, wherein the beverage whitener is contained within the capsule.

14. A capsule according to claim 13, wherein the capsule comprises front and back sheets of flexible film material bonding together around the edges thereof to define a sachet.

15. A capsule according to claim 13, wherein the capsule is substantially air and moisture impermeable before use in order to preserve the whitener in a shelf stable condition.

16. A capsule according to claim 14, wherein the dry weight of the whitener in the sachet is from about 5 to about 15 g.

17. A method of making a foamed beverage comprising the steps of: providing a beverage whitener composition comprising, by weight based on the dry weight of the composition: from about 50% to about 80% of a milk powder; from about 5% to about 30% of whey solids, and from about 10% to about 30% of one or more added sugars, and
dispersing the composition in water, and high shear mixing to form a foamed liquid dispersion.

18. A method of making a foamed beverage according to claim 17, wherein the step of dispersing comprises low shear mixing to disperse the whitener in water followed by the high shear mixing to foam the dispersion.

19. A method of making a foamed beverage according to claim 17, wherein the high shear mixing is provided by injecting a high velocity jet of water into the dispersion in a receptacle, or by injecting the dispersion itself into a receptacle as a high velocity jet, wherein said high velocity jets have a jet diameter of from about 0.5 to about 2 mm, to produce a foamed liquid in the receptacle.

20. A method of making a foamed beverage according to claim 19, wherein the jet velocity of the liquid jet is from about 3 to about 50 m/s, preferably from about 5 to about 15 m/s.

21. A capsule containing a beverage whitener comprising a powdered beverage whitener composition comprising, by weight based on the dry weight of the composition: from about 10% to about 60% of proteins and from about 25% to about 85% of sugars and less than about 2% by weight of fats, the proteins comprise added whey proteins, wherein the beverage whitener is contained within the capsule.

22. A capsule according to claim 21, wherein the capsule comprises front and back sheets of flexible film material bonding together around the edges thereof to define a sachet.

23. A capsule according to claim 21, wherein the capsule is substantially air and moisture impermeable before use in order to preserve the whitener in a shelf stable condition.

24. A capsule according to claim 22, wherein the dry weight of the whitener in the sachet is from about 5 to about 15 g.

25. A method of making a foamed beverage comprising the steps of:
providing a beverage whitener composition comprising, by weight based on the dry weight of the composition: from about 10% to about 60% of proteins and from about 25% to about 85% of sugars and less than about 2% by weight of fats, whereby the proteins comprise added whey proteins, and
dispersing the composition in water, and high shear mixing to form a foamed liquid dispersion.

26. A method of making a foamed beverage according to claim 25, wherein the step of dispersing comprises low shear mixing to disperse the whitener in water followed by the high shear mixing to foam the dispersion.

27. A method of making a foamed beverage according to claim 25, wherein the high shear mixing is provided by injecting a high velocity jet of water into the dispersion in a receptacle, or by injecting the dispersion itself into a receptacle as a high velocity jet, wherein said high velocity jets have a jet diameter of from about 0.5 to about 2 mm, to produce a foamed liquid in the receptacle.

28. A method of making a foamed beverage according to claim 27, wherein the jet velocity of the liquid jet is from about 3 to about 50 m/s, preferably from about 5 to about 15 m/s.
